(19) United States
(12) Patent Application Publication
(10) Pub. No.: US 2025/0059402 A1
(43) Pub. Date: Feb. 20, 2025

(54) PHOTOCURABLE COMPOSITIONS

(71) Applicant: Henkel AG & Co. KGaA, Duesseldorf (DE)

(72) Inventor: Andrew D. Messana, Newington, CT (US)

(21) Appl. No.: 18/934,853

(22) Filed: Nov. 1, 2024

Related U.S. Application Data
(63) Continuation of application No. PCT/US2023/020667, filed on May 2, 2023.
(60) Provisional application No. 63/337,293, filed on May 2, 2022.

(51) Int. Cl. C09J 4/00; C08K 5/45; C09J 5/00; C09J 11/06; C09J 133/06; C09J 133/14; C09J 133/26

(52) U.S. Cl. CPC C09J 4/00; C09J 5/00; C09J 11/06; C09J 133/066; C09J 133/14; C09J 133/26; C08K 5/45

(57) ABSTRACT

Photocurable compositions are provided herein, which provide a balance of fast curing properties at exposure to radiation in the electromagnetic spectrum and impressive cure through depth.

### BACKGROUND

### Field

The present invention relates to photocurable compositions having a balance of fast curing properties at exposure to radiation in the electromagnetic spectrum and impressive cure through depth.

### Brief Description of Related Technology

Photocurable adhesive compositions are legion, in large measure for medical device assembly applications. Many have been commercialized with physical properties, such as good tack-free cure time, good fixture time, and good tensile strength being promoted. Conspicuously absent from this list is cure through depth.

Cure through depth means the ability of a dispensed sample of a photocurable adhesive to react such that the reacted adhesive is not flowable in the “z” direction. Cure through depth has been an elusive physical property to achieve in photocurable adhesives.

U.S. Pat. No. 6,080,450 (Cantor) is directed to a polymerizable liquid formulation that is curable by a combination of ultraviolet and visible radiation to a fully cured solid deposit that exhibits a bright fluorescent response, comprising: a free radical-polymerizable liquid composition; about 0.02 to 1.0 percent of a fluorescing agent, based upon the weight of the formulation, the fluorescing agent fluorescing at wavelengths above 350 nm and including at least a portion of the visible region of the spectrum; and a catalyst system including 0.15 to 1.0 percent, based upon the weight of the formulation, of a phosphine oxide photoinitiator component that responds to actinic radiation in a band of radiation that encompasses a range up to at least 410 nm and that includes at least a portion of the visible spectral region and at least a portion of the ultraviolet spectral region, to generate free radicals and to thereby effect polymerization of the polymerizable liquid composition, the formulation being substantially free of non-reactive solvents.

The focus of the '450 patent is to provide a polymerizable composition that is curable by actinic radiation and that contains a luminescing agent, wherein the luminescing effect can be increased while maintaining or improving the cure properties of the composition.

Nonetheless, improvements of cure through depth in photocurable compositions would be desirable.

### SUMMARY

Provided herein is a photocurable composition that comprises:
(a) a (meth)acrylate component;
(b) a (meth)acrylate-functionalized resin component; and
(c) an initiator component comprising a combination of a blue fluorescent compound and a co-initiator. The fluorescent compound should absorb energy below a wavelength of about 400 nm (such as as low as 180 nm) and emit energy (or, fluoresces) above a wavelength of about 400 nm (such as up to about 600 nm). Desirably, the fluorescent compound comprises 2,5-thiophenediylbis(5-tert-butyl-1,3-benzoxazole).

When exposed to a source of radiation, such as that which emits radiation at a wavelength of 405 nm at an intensity of for instance 100 mW/cm², desirably 200 mW/cm², for a period of time of at least about 30 seconds, the composition cures to a cured composition exhibiting a depth of cure through a volume of the composition.

In one aspect, the present invention provides a photocurable composition comprising (a) isobornyl (meth)acrylate in an amount of about 5 to about 50 percent by weight, such as about 15 to about 40 percent by weight based on the total weight of the composition; (b) N,N-dimethylacrylamide in an amount of from about 20 to about 30 percent by weight based on the total weight of the composition; (c) a (meth)acrylate-functionalized resin in an amount of from about 15 to about 50 percent by weight, such as about 25 to about 35 percent by weight based on the total weight of the composition; and (d) as an initiator component, a combination of 2,5-thiophenediylbis(5-tert-butyl-1,3-benzoxazole) and benzoyl peroxide.

In another aspect, the present invention provides a method of curing the photocurable composition, comprising the steps of applying the inventive composition to at least a first substrate and exposing the composition to radiation in the electromagnetic spectrum, such as may be emitted from a light-emitting diode (“LED”), so as to cure the composition through a depth of cure.

It was surprisingly found that an initiator component comprising a combination of a blue fluorescent compound and a co-initiator provides a depth of cure to the composition as it cures when exposed to radiation in the electromagnetic spectrum, such as may be emitted from an LED. More specifically, the initiator component is a combination of a fluorescent compound and a co-initiator. Desirably, the fluorescent compound comprises 2,5-thiophenediylbis(5-tert-butyl-1,3-benzoxazole). And significantly the initiator component should be free of added phosphine oxide photoinitiator.

The components of the inventive compositions-including at least the urethane (meth)acrylate resin component; the (meth)acrylate component; and the initiator component—may be mixed together in any order and for a time sufficient to ensure proper dissolution or dispersion. This composition may be cured, when desired, by radiation in the electromagnetic spectrum, such as UV, visible and UV/VIS radiation, particularly 405 nm radiation, as emitted by a LED lamp like a LOCTITE-branded CureJet.

### DETAILED DESCRIPTION

As noted above, the present invention provides, in one aspect, a photocurable composition comprising:
(a) a (meth)acrylate component;
(b) a (meth)acrylate-functionalized resin component; and
(c) an initiator component comprising a combination of a blue fluorescent compound and a co-initiator. The fluorescent compound should absorb energy below a wavelength of about 400 nm (such as as low as 180 nm) and emit energy (or, fluoresces) above a wavelength of about 400 nm (such as up to about 600 nm). Desirably, the fluorescent compound comprises 2,5-thiophenediylbis(5-tert-butyl-1,3-benzoxazole). And the inventive composition should be free of added phosphine oxide photoinitiator.

When exposed to a source of radiation, such as that which emits radiation at a wavelength of 405 nm at an intensity of for instance 100 mW/cm², such as 200 mW/cm², for a period of time of at least about 30 seconds, the composition cures to a cured composition exhibiting a depth of cure (also called cured through depth or volume) through the volume of the composition.

In one aspect, the present invention provides a photocurable composition comprising (a) isobornyl (meth)acrylate in an amount of about 5 percent by weight to about 50 percent by weight, such as about 15 percent by weight to about 40 percent by weight based on the total weight of the composition; (b) N,N-dimethylacrylamide in an amount of from about 20 percent by weight to about 30 percent by weight based on the total weight of the composition; (c) a (meth)acrylate-functionalized resin in an amount of from about 15 percent by weight to about 50 percent by weight, such as about 25 percent by weight to about 35 percent by weight based on the total weight of the composition; and (d) as an initiator component, a combination of 2,5-thiophenediylbis(5-tert-butyl-1,3-benzoxazole) and benzoyl peroxide.

In another aspect, the present invention provides a method of curing the photocurable composition, comprising the steps of applying the inventive composition to at least a first substrate and exposing the composition to radiation in the electromagnetic spectrum, such as may be emitted from a light-emitting diode (“LED”), so as to cure the composition through a depth of cure or through the volume of the composition.

It was surprisingly found that an initiator component comprising a combination of a blue fluorescent compound and a co-initiator provides a depth of cure to the composition as the composition cures when exposed to radiation in the electromagnetic spectrum, such as may be emitted from an LED. More specifically, the initiator component is a combination of 2,5-thiophenediylbis(5-tert-butyl-1,3-benzoxazole) as a blue fluorescent compound and benzoyl peroxide as a co-initiator. Ordinarily, photocurable compositions form a skin over layer at the surface of the composition and provide little to no cure through depth without the presence of a secondary cure mechanism, such as moisture cure or anaerobic cure. Here, however, the inventive compositions exhibit a depth or cure through the volume of the composition when so exposed to radiation in the electromagnetic spectrum

The (meth)acrylate component may include a host of (meth)acrylate monomers, with some of the (meth)acrylate monomers being aromatic, while others are aliphatic and still others are cycloaliphatic. Examples of such (meth)acrylate monomers include di- or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), and bisphenol-F mono and di(meth)acrylates, such as ethoxylated bisphenol-F (meth)acrylate.

The (meth)acrylate component should be present in an amount of about 25 percent by weight to about 80 percent by weight, such as about 55 percent by weight to about 65 percent by weight, based on the total weight of the composition.

Particularly desirable (meth)acrylate monomers include isobornyl (meth)acrylate and N,N-dimethylacrylamide, which may be used in combination.

When used in combination, (a) isobornyl (meth)acrylate should be present in an amount of about 5 percent by weight to about 50 percent by weight, such as about 15 percent by weight to about 40 percent by weight based on the total weight of the composition, and (b) N,N-dimethylacrylamide should be present in an amount of from about 20 percent by weight to about 30 percent by weight based on the total weight of the composition.

The (meth)acrylate-functionalized resin component includes oligomers, particularly oligomers with urethane linkages, having a number average molecular weight of from about 500 to about 100,000 Mn, such as about 2,500 to about 25,000 Mn. The number average molecular can be measured for example by gel permeation chromatography.

In one aspect, the inventive compositions include a (meth)acrylate-functionalized resin component present in an amount of from about 15 percent by weight to about 50 percent by weight, such as about 25 percent by weight to about 35 percent by weight based on the total weight of the composition.

Examples of a (meth)acrylate-functionalized resin are (meth)acrylate-functionalized urethanes, (meth)acrylate-functionalized polyesters, and poly(isobutylene) di(meth)acrylates.

(Meth)acrylate-functionalized urethanes (or urethane (meth)acrylate resins) suitable as the (meth)acrylate-functionalized resin component include those disclosed in U.S. Pat. Nos. 4,018,851, 4,295,909 and 4,309,526 to Baccei, and U.S. Pat. Nos. Re 33,211, 4,751,273, 4,775,732, 5,019,636 and 5,139,872 to Lapin et al., for instance.

Other examples of such (meth)acrylate-functionalized urethanes include a tetramethylene glycol urethane acrylate oligomer and a propylene glycol urethane acrylate oligomer.

Still other (meth)acrylate-functionalized urethanes are monofunctional urethane acrylate oligomers, such as a polypropylene terminated with 4,4′-methylenebis(cyclohexylisocyanate), capped with 2-hydroxyethyl acrylate and 1-dodosanol.

They also include difunctional urethane methacrylate oligomers such as a polytetramethylene glycol ether terminated with tolulene-2,4-diisocyanate, capped with 2-hydroxyethyl methacrylate; a polytetramethylene glycol ether terminated with isophorone diisocyanate, capped with 2-hydroxyethyl methacrylate; a polytetramethylene glycol ether terminated with 4,4′-methylenebis(cyclohexylisocyanate), capped with 2-hydroxyethyl methacrylate; and a polypropylene glycol terminated with tolylene-2,4-diisocyanate, capped with 2-hydroxyethyl methacrylate.

The (meth)acrylate-functionalized resin component may be a multi-(such as di- or tri-) functional urethane acrylate oligomer, more desirably an aliphatic polyether urethane acrylate. An example of a suitable (meth)acrylate-functionalized resin component is BOMAR BR-582-E8 (commercially available from Dymax Corporation, Torrington, CT), which is described as an aliphatic urethane acrylate oligomer having a polyether backbone. BOMAR BR-582-E8 is listed in the tables below.

Dymax also makes available commercially a series of other (meth)acrylate-functionalized urethanes, which have a functionality of between about 1 and about 3, and demonstrate a percent elongation of greater than about 50. One such (meth)acrylate-functionalized urethane from Dymax is a tri-functional urethane acrylate oligomer, more specifically an aliphatic polyether urethane triacrylate, known as BR-990.

Among the (meth)acrylate-functionalized urethanes are those based on polyesters or polyethers, which are reacted with aromatic, aliphatic, or cycloaliphatic diisocyanates and capped with hydroxy acrylates.

For instance, difunctional urethane acrylate oligomers, such as a polyester of hexanedioic acid and diethylene glycol, terminated with isophorone diisocyanate, capped with 2-hydroxyethyl acrylate (CAS 72121-94-9); a polypropylene glycol terminated with tolyene-2,6-diisocyanate, capped with 2-hydroxyethylacrylate (CAS 37302-70-8); a polyester of hexanedioic acid and diethylene glycol, terminated with 4,4′-methylenebis(cyclohexyl isocyanate), capped with 2-hydroxyethyl acrylate (CAS 69011-33-2); a polyester of hexanedioic acid, 1,2-ethanediol, and 1,2 propanediol, terminated with tolylene-2,4-diisocyanate, capped with 2-hydroxyethyl acrylate (CAS 69011-31-0); a polyester of hexanedioic acid, 1,2-ethanediol, and 1,2 propanediol, terminated with 4,4′-methylenebis(cyclohexyl isocyanate, capped with 2-hydroxyethyl acrylate (CAS 69011-32-1); and a polytetramethylene glycol ether terminated with 4,4′-methylenebis(cyclohexylisocyanate), capped with 2-hydroxyethyl acrylate.

The following commercially available (meth)acrylate-functionalized urethane resins from Dymax that may be useful include BR-930D [described by the manufacturer as a polyether urethane acrylate that is flexible and has weatherability, with a nominal viscosity of 7,700 at 60° C. and a Tg (° C.) by DMA of 95. The manufacturer promotes BR-930D as having the following features for select applications ideal for 3D printing resins; high heat-distortion temperature; provides good toughness and impact resistance; enhances weatherability and low skin irritation]; and BR 7432G130 [described by the manufacturer as a polyester urethane acrylate that is flexible and has weatherability, with a nominal viscosity of 80,000 at 25° C. and a Tg (° C.) by DMA of 28. The manufacturer promotes BR-7432G130 as having the following features for select applications: imparts toughness; high tensile strength; improves impact resistance; adheres to polymer films; elastomeric; and BR-3741AJ [described by the manufacturer as a polyether urethane acrylate that is flexible and has weatherability, with a nominal viscosity of 25,000 at 60° C. and a Tg (° C.) by DMA of −50. The manufacturer promotes BR-3741AJ as having the following features for select applications; enhances softness and flexibility; improved optical clarity; non-yellowing; improves adhesion; adheres to a wide range of substrates; exhibits hydrolytic stability; oil and chemical resistant and ideal for PSAs].

Thus, (meth)acrylate-functionalized urethanes may be chosen from a variety of materials, some of which are commercially available from Dymax and are recited below in the tables together with certain salient features:

Urethane Acrylates

| | | |
|---|---|---|
| | | Elongation at |
| Name | Functionality | Break, % |

Polyester Urethane Acrylates

| | | |
|---|---|---|
| BR-744BT | 2 | 407 |
| BR-744SD | 2 | 321 |
| BR-7432GB | 2 | 350 |
| BR-7432GI30 | 2 | 260 |

Polyester Urethane Methacrylates

| | | |
|---|---|---|
| BR-742M | 2 | 60 |
| BR-742MS | 2 | 60 |

Polyether Urethane Acrylates

| | | |
|---|---|---|
| BR-302 | 2 | 102.5 |
| BR-343 | 2 | 57 |
| BR-344 | 2 | 110 |
| BR-345 | 2 | 260 |
| BR-372 | 2 | 90 |
| BR-374 | 2 | 285 |
| BR-541S | 2 | 120 |
| BR-543 | 2 | 200 |
| BR-571 | 2 | 115 |
| BR-582-E8 | 2.4 | 180 |
| BR-582H15 | 2.4 | 65 |
| BR-582I10 | 2.4 | 180 |
| BR-3042 | 2 | 500 |
| BR-3641AA | 1.3 | 580 |
| BR-3641AJ | 1.3 | 2,900 |
| BR-3741 | 2 | 152 |
| BR-3741AJ | 1.3 | 1,000 |
| BR-5825130 | 2.4 | 130 |

Polyether Urethane Methacrylates

| | | |
|---|---|---|
| BR-116 | 3 | 57 |
| BR-202 | 2 | 75 |
| BR-204 | 2 | 160 |
| BR-541MB | 2 | 63 |
| BR-543MB | 2 | 51 |
| BR-551M | 2 | 74 |
| BR-551ME | 2 | 60 |
| BR-571MB | 2 | 110 |
| XR-145S | 3 | 140 |

As an example, the BR-345 (meth)acrylate-functionalized urethane may be made according to the following reaction scheme:

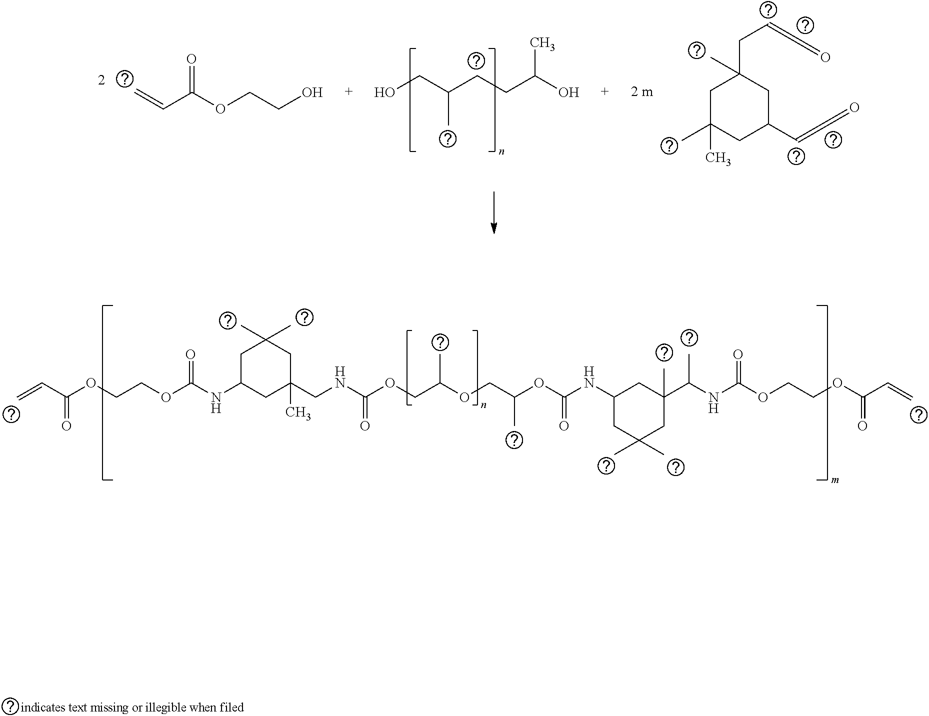

Another example of a useful (meth)acrylate-functionalized urethane is a block resin noted as cyclohexanol, 4,4-(1-methylethylidene)bis-, polymer with 1,3-disocyanatomethylbenzene and tetrahydrofuran, propylene glycol monomer (CAS No. 2243075-64-9), made in sequential steps from the reaction of the propylene glycol monomer and dicarboxylic acids to form polyester diols, followed by reaction with toluene diisocyanate and finally capping with hydroxy propyl (meth)acrylate.

Still another example of a useful (meth)acrylate-functionalized urethane is a block resin made from a saturated polyester diol (such as one sold under the tradename DESMOPHEN S-1011-35) and dicyclohexylmethane-4,4′-diisocyanate (available commercially as DESMODUR W), and capping with 2-hydroxy ethyl acrylate, the block resin being diluted with IBOA.

A resin containing a central segment of POLYMEG 2000 (polytetramethylene ether glycol produced by polymerizing tetrahydrofuran to form a linear diol with a backbone of repeating tetramethylene units connected by ether linkages, and capped with primary hydroxyl units) to which are attached through urethane linkages either TDI-HBPA or IPDI-HMTD and capped with either TDI-HPMA or IPDI-HEMA may be used. Also, a resin made from a hydroxy functionalized polyether, polyester (available commercially as KURARAY Polyol P-2010) and TDI, together with hydroxypropyl (meth)acrylate and isobornyl (meth)acrylate may be used. Likewise, a resin made from polyTHF (with a weight average molecular weight (“Mw”) of 2,000) and TDI, together with HBPA, hydroxypropyl (meth)acrylate, hydroxyethyl (meth)acrylate and isobornyl (meth)acrylate may also be used.

In some cases, such as described in U.S. Pat. No. 10,745,590, hydrophobic (meth)acrylate-functionalized urethanes may be desirable, such as those having a Mw of 35000 to 60000 g/mol, as determined by gel permeation chromatography (“GPC”). With the Mw falling within this range, the cured products may also demonstrate strong cohesion and high elongation. Preferably, hydrophobic (meth)acrylate-functionalized urethanes should have a functionality of the (meth)acrylate group of equal to or less than 2. With the functionality of the (meth)acrylate group falling within this range, the cured products may also demonstrate high elongation. These hydrophobic (meth)acrylate-functionalized urethanes should have a glass transition temperature value (“Tg”) of from −60° C. to 20° C., as determined by differential scanning calorimetry (“DSC”).

Hydrophobic (meth)acrylate-functionalized urethanes may be selected from aliphatic urethane (meth)acrylates, aromatic urethane (meth)acrylates and mixtures thereof, such as polybutadiene based urethane (meth)acrylates, polyisobutylene based urethane (meth)acrylates, polyisoprene based urethane (meth)acrylate, polybutyl rubber based urethane (meth)acrylates and the mixtures thereof. Suitable commercially available hydrophobic urethane (meth)acrylates include UT-4462 and UV36301B90 available from Nippon Gohsei; CN 9014 available from Sartomer; and SUO-H8628 available from SHIIN-A T&C.

(Meth)acrylate-functionalized urethanes may also include polyurethane block copolymer having a backbone of alternating hard and soft segments and at least two ends. The ends each may be terminated with a vinyl ether, alkenyl ether or (meth)acrylate group. Such polyurethane block copolymers may be represented by the following general formula:

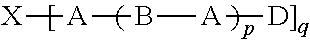

wherein A is a hard segment, such as the reaction product of a polyisocyanate and an aromatic, heterocyclic or cycloaliphatic polyol;
B is a divalent soft segment and X is a q-valent soft segment, such as where B and X may be a divalent and a multivalent group, respectively, derived from a polyether polyol, polyester polyol or hydrogenated hydrocarbon elastomer, such as polybutadiene;
D is a vinyl ether or (meth)acrylate group, such as where the vinyl ether may be derived from hydroxy functional vinyl ethers, for instance 2-hydroxyethyl vinyl ether, 4-hydroxybutyl vinyl ether, cyclohexanedimethanol monovinyl ether, diethylene glycol monovinyl ether, 1,6-hexanediol monovinyl ether and 3-aminopropyl vinyl ether, or the vinyl ether terminal groups may be derived from an amino functional vinyl ether, in which case vinyl ether urea capped polyurethanes may be obtained;
p is 0-10; and
q is 2-6.

Another example of a (meth)acrylate-functionalized urethane is one with a polyurethane backbone, at least a portion of which includes a urethane linkage formed from isophorane diisocyanate. For instance, such a (meth)acrylate-functionalized urethane is made from an alkylane glycol (such as polypropylene glycol), isophorane diisocyanate and hydroxy alkyl (meth)acrylate (such as hydroxyl ethyl acrylate). Other examples include a polyester of hexanedioic acid, diethylene glycol, terminated with isophorone diisocyanate, capped with 2-hydroxyethyl acrylate; a polytetramethylene glycol ether terminated with isophorone diisocyanate, capped with 2-hydroxyethyl methacrylate; and a hydroxy terminated polybutadiene terminated with isophorone diisocyanate, capped with 2-hydroxyethyl acrylate.

The initiator component comprising a combination of a blue fluorescent compound and a co-initiator.

The initiator component should be present in an amount from about 0.01 percent by weight to about 5 percent by weight, such as from about 0.5 percent by weight to about 4 percent by weight based on the total weight of the composition.

The blue fluorescent compound may be selected from many known such compounds.

The blue fluorescent compound should absorb energy below a wavelength of about 400 nm (such as as low as 180 nm) and emit energy (or, fluoresces) above a wavelength of about 400 nm (such as up to about 600 nm).

The blue fluorescent compound may also be considered a fluorescent brightener. Here, the fluorescent brightener may include benzoxazole and derivatives thereof, bis-benzoxazoles; bis-benzoxazolyl-stilbenes; bis-benzoxazolyl-thiophenes, thiophenediyl benzoxazoles, and/or 2,5-thiophenediylbis-(5-tert-butyl-1,3-benzoxazoles).

Examples of commercially available fluorescent brighteners include Tinopal OB and Uvitex OB, each from BASF Corporation. These brighteners absorb UV radiation and re-emit visible blue light.

Other examples of such fluorescent compounds include

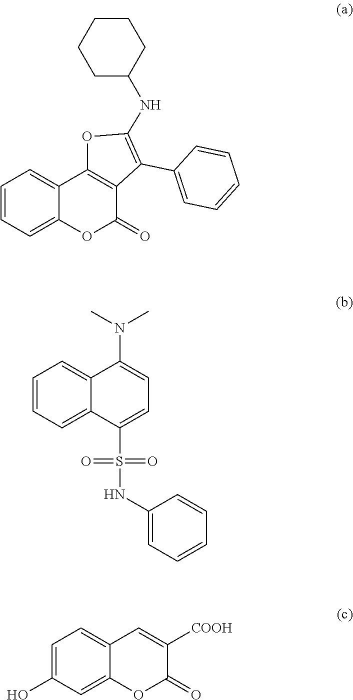 [SMILES: O=c1oc2ccccc2c2oc(NC3CCCCC3)c(-c3ccccc3)c12 ; CN(C)c1ccc(S(=O)(=O)Nc2ccccc2)c2ccccc12 ; O=C(O)c1cc2ccc(O)cc2oc1=O]

In addition, other illustrative fluorescent compounds having utility herein include

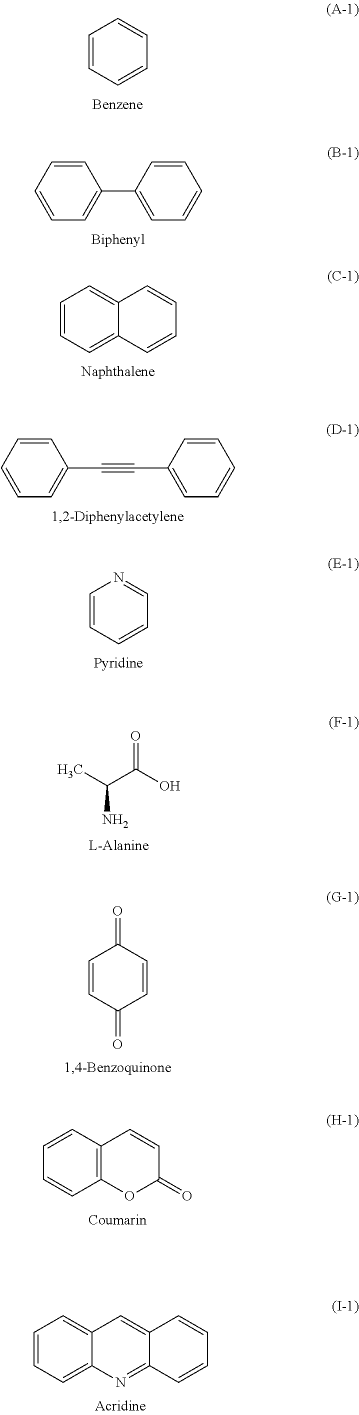

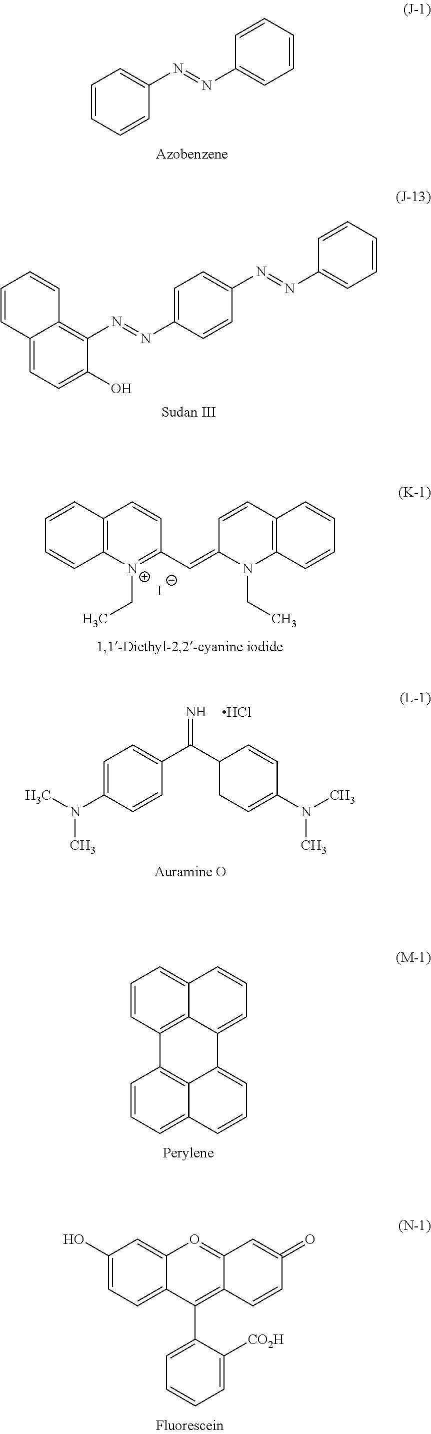

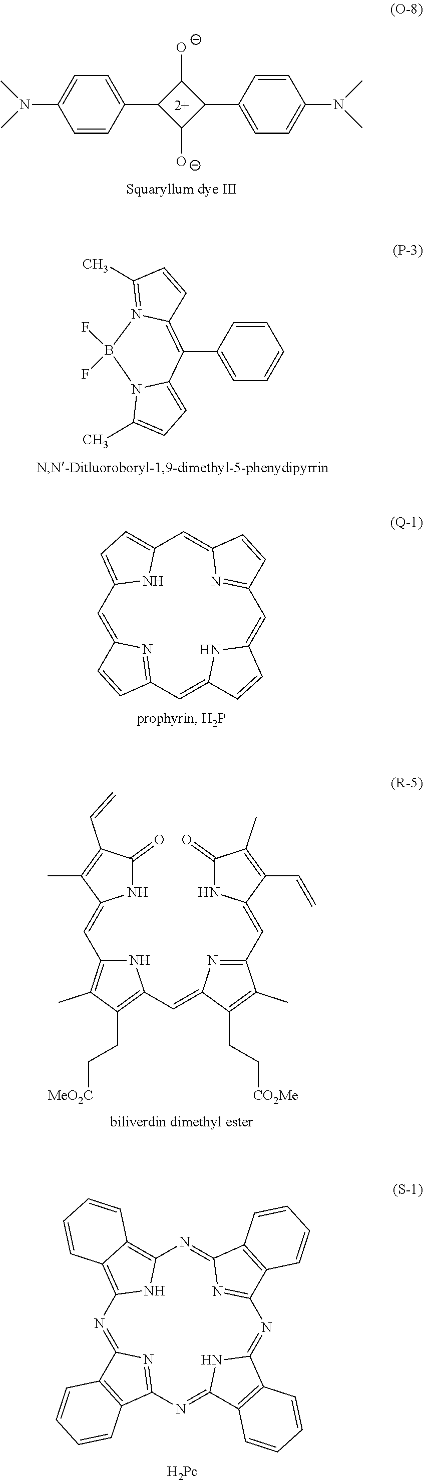

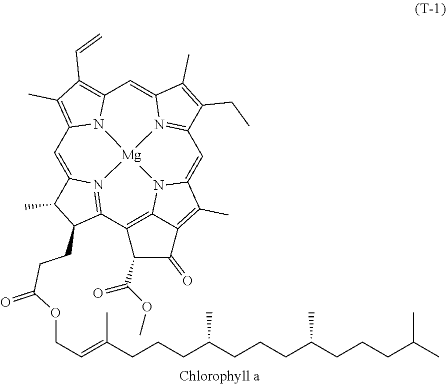

Desirably, however, the blue fluorescent compound should be 2,5-thiophenediylbis(5-tert-butyl-1,3-benzoxazole).

The blue fluorescent compound may be present in an amount from about 0.01 percent by weight to about 5 percent by weight, such as from about 0.5 percent by weight to about 4 percent by weight by weight based on the total weight of the composition.

In some embodiments of the present invention, the amount of the blue fluorescent compound is from 0% to 2%, such as from 0.05 to 1%, and desirably from 0.05% to 0.5% by weight based on the total weight of the light curable composition.

The co-initiator may be selected from a host of materials, provided the co-initiator acts by way of a free radical mechanism. Desirably, the co-initiator should be a benzoyl peroxide.

The co-initiator may be present in an amount from about 0.01 percent by weight to about 5 percent by weight, such as from about 0.5 percent by weight to about 4 percent by weight by weight based on the total weight of the composition.

The inventive composition may also include one or more additives, such as colorants like pigments or dyes. Carbon black is one such colorant, and may be used in an amount of about 0.0025 to about 5 percent by weight of the composition, such as about 0.1 to about 1 percent by weight of the composition. Titanium dioxide is another useful colorant, and may be used in an amount of about 0.01 to about 3 percent by weight of the composition, such as about 0.1 to about 1 percent by weight of the composition. In addition, colors in the form or dyes or pigments may be used, and selected from red, yellow, blue, green and violet, for instance.

In one aspect, the present invention provides a method of curing the inventive compositions comprising the steps of applying the compositions to at least a first substrate and exposing the composition to radiation in the electromagnetic spectrum, such as may be emitted from an LED source like those described herein.

At least one substrate may be a plastics material, which desirably should be transparent to UV, visible or UV/VIS light. By way of example, the plastics material which is desirably transparent to such radiation can be selected from at least one of polyvinyl chloride, polyethylene, polypropylene, polycarbonate, acrylonitrile butadiene styrene, polyethylene terephthalate and thermoplastic elastomers.

At least one of the first substrate and the second substrate to be bonded using a composition of the invention can comprise tubing:
(i) for the transfer, including drainage, of medical fluids including liquids such as electrolyte e.g. saline or blood and gases such as oxygen;
(ii) in a form which is inserted into the body, such as a catheter, for example for insertion within the vasculature, or for insertion within a tract such as a urinary tract;
(iii) part of an implantable device;
(iv) for connecting to a cannula which is for insertion into a subject for example an intravenous catheter;
(v) for connecting to a medical device such as a pump, including insulin pumps, or haemodialysis equipment;
(vi) for use as a sheath, for example to house wires, for example to house wires from medical equipment.

### Examples

The inventive compositions cure through volume about 30 seconds upon exposure to radiation in the electromagnetic spectrum for example at an intensity of 100 mW/cm² using LED light sources which emit light at a wavelength of 405 nm.

Initially, three commercially available light curable products were evaluated and certain physical properties illustrated as a benchmark of their performance. The commercial products are: LOCTITE 3341, LOCTITE 3921, and LOCTITE 3961. As reported by the manufacturer,

LOCTITE 3341 is a transparent, light yellow, light-cured, universal, acrylic-based instant adhesive, suitable for metals and stress-sensitive plastics with a high, on-demand, curing speed. Depth of cure is >13 mm. Tack free time 15 secs. Fixturing time is 8 secs. Shore hardness: D 27. Low viscosity 500 mPa·s. The manufacturer reports that LOCTITE 3341 contains urethane acrylate oligomer (30-60 weight percent), N′N-dimethylacrylamide (10-30 weight percent), acrylate ester (10-30 weight percent), urethane acrylate oligomer (10-30 weight percent), isobornyl acrylate (5-10 weight percent), phosphine oxide (1-5 weight percent), acrylate ester (1-5 weight percent), and 2-hydroxyethyl acrylate (0.1-1 weight percent).

LOCTITE 3921 is a light-cured, acrylic-based adhesive formulated to provide flexible bonds when joining stress-sensitive plastics. The product offers a depth of cure >13 mm and a fixturing time of just 3 secs. The manufacturer reports that LOCTITE 3921 contains N′N-dimethylacrylamide (10-30 weight percent), acrylate monomer (10-30 weight percent), and a substituted silane (1-5 weight percent).

LOCTITE 3961 contains isobornyl acrylate (30-60 weight percent), N′N-dimethylacrylamide (10-30 weight percent), photoinitiator (1-3 weight percent), urethane acrylate oligomer (10-30 weight percent), ethyl phenyl(2,4,6-trimethylbenzoyl)phosphinate (1-5 weight percent), acrylic acid oligomers (1-5 weight percent), gamma-glycidoxypropyl trimethoxysilane (1-5 weight percent), 2-propenoic acid (1-5 weight percent), 2-carboxyethyl ester (1-5 weight percent), acrylate ester (1-5 weight percent), acrylic acid (1-5 weight percent), and 2-hydroxyethyl acrylate (0.1-1 weight percent).

A 3 gram volume of each sample was dispensed into an aluminum pan and exposed to radiation in the electromagnetic spectrum emitted from a LOCTITE-branded 405 nm CureJet (an LED radiation source) and cured at 100 mW/cm² light intensity.

To each of these three commercially available products was added with mixing 0.5 percent by weight of LUPEROX A98 (anhydrous benzoyl peroxide), and a volume of these samples (Sample Nos. 1-3) was dispensed into an aluminum pan and exposed to radiation in the electromagnetic spectrum emitted from a LOCTITE-branded 405 nm CureJet and cured at 100 mW/cm² light intensity.

Comparing the depth of cure observed of the three commercial samples with Sample Nos. 1-3 which were based on the respective commercial samples with the addition of the benzoyl peroxide, one can see a pronounced increase in the depth of cure with as little as a 5 second exposure and certainly with a 10 second exposure. Table 1 below captures the data observed.

TABLE 1

Sample No.

| | 1 | 2 | 3 | 3341 | 3921 | 3961 |
|---|---|---|---|---|---|---|
| | DOC | DOC | DOC | DOC | DOC | DOC |
| Time | (mm) | (mm) | (mm) | (mm) | (mm) | (mm) |
| (secs) | Max | Max | Max | Max | Max | Max |
| 2 | 1.2 | 1.2 | 1.3 | 0.9 | 1.2 | 1.3 |
| 5 | 2.1 | 4.5 | 4.4 | 1.9 | 1.9 | 1.9 |
| 10 | 4.8 | 4.5 | 4.9 | 2.1 | 2.7 | 1.9 |

The information captured in Table 1 shows improved depth of cure for each of Sample Nos. 1-3 as compared with the respective base commercial products in as little as 5 seconds of light exposure and quite pronounced after 10 seconds of light exposure.

Next, LOCTITE 3921 was used as a control and the benzoyl peroxide was added in an amount of 0.5 percent by weight to make Sample No. 4 and in an amount of 0.1 percent by weight to make Sample No. 5. Each of these three samples was dispensed into a beaker and exposed to radiation in the electromagnetic spectrum emitted from a LOCTITE-branded 405 nm CureJet for 30 seconds at 100 mW/cm² light intensity. LOCTITE 3921 and Sample No. 4 were dispensed in 20 gram portions, whereas Sample No. 5 was dispensed in a 30 gram portion. Table 2 below captures the data observed.

TABLE 2
Sample No.

| 4 | 5 | 3921 |
|---|---|---|
| DOC | DOC | DOC |
| (mm) | (mm) | (mm) |
| Max | Max | Max |
| 22.3 | 26.3 | 5.0 |

The information captured in Table 2 shows improved depth of cure for each of Sample Nos. 4-5 as compared with the base commercial product, LOCTITE 3921, after 30 seconds of exposure to radiation in the electromagnetic spectrum. Indeed, upwards of 4 to 5 times the magnitude of depth of cure was observed with the addition of the benzol peroxide.

Next, three commercially available light curable products containing a fluorescent compound were evaluated and certain physical properties illustrated as a benchmark of their performance. The commercial products are: LOCTITE 3041, LOCTITE 3963, and LOCTITE 3951. As reported by the manufacturer, LOCTITE 3041 is designed for bonding cannulae into hubs, syringes and lancets.

LOCTITE 3963 is a low viscosity light cure adhesive designed for applications where a fast curing, rigid adhesive is required. It is an optimal choice when bonding various metals and plastics. LOCTITE 3963 maintains high adhesion to rigid substrates such as stainless steel, polycarbonate, ABS, Acrylic, HDPE (when treated), PP (when treated) and more. LOCTITE 3963 is suitable for use in the assembly of disposable medical devices.

LOCTITE 3951 is a low viscosity light cure adhesive designed for applications where a fast curing, highly flexible adhesive is required. It is an optimal choice when bonding plasticized PVC, TPEs, and thermoset rubbers. It also maintains high adhesion to rigid substrates such as polycarbonate, ABS, Acrylic, HDPE (when treated), PP (when treated) and more. LOCTITE 3951 is suitable for use in the assembly of disposable medical devices.

Each thus contains 2,5-thiophenediylbis(5-tert-butyl-1,3-benzoxazole), though at different concentrations. The presence of this compound in each of these three commercial products used in the assembly of disposable medical devices permits facile on-part inspection of its location on the part to be bonded.

Moving away from one or more of the commercial samples as the control(s) toward a model base formulation, an additional evaluation was conducted. The model base formulation was made from IBOA, 35 percent by weight, DMAA, 35 percent by weight and BOMAR BR-582-E8, 30 percent by weight. BOMAR BR-582-E8 is an aliphatic polyether urethane acrylate oligomer, which is said by the manufacturer, Dymax Corporation, Torrington, CT, to provide a balance of toughness and flexibility. Dymax highly recommends this oligomer product for use in single-coat, flexible coatings on metal and plastic substrates and is an excellent choice for impact and bend resistant coatings, demonstrating abrasion resistance, flexibility, gloss, hydrolytic stability, weather resistance and non-yellowing properties too. Dymax reports the oligomer product to have a Tg by DMA of 23° C. and a nominal viscosity of 60,000 cP at 50° C., and to bond to a variety of substrates, though not to high density polyethylene.

To the model base formulation was added a benzoyl peroxide in an amount of 0.5 percent by weight. To the model base formulation was also added benzoyl peroxide in an amount of 0.5 percent by weight and a fluorescent compound was also added. In two cases, the fluorescent compound is Tinopal; in a third case the fluorescent compound is Natmar Scanning Compound SC-25, available commercially from Angstrom Technologies, Inc., Florence, KY. According to the manufacturer SC-25 is one of Angstrom's “World Class” organic pigments and is described as an organic pigment that can be used as a dye in toluene, acetone, and alcohols. The manufacturer reports that SC-25 is a combination of 50-60 percent by weight organometallic compound and 40-50 percent by weight a phosphoroaryl compound. It has a UV excitation color of red and a fluorescence emission of 615 nm. In other words, SC-25 absorbs UV radiation and re-emits visible red light.

The Tinopal was used in an amount of 0.5 percent by weight or 1 percent by weight; the SC-25 was used in an amount of 1 percent by weight. Thus, here four samples were created, referred to as Sample Nos. 6-9.

Each of these four samples were dispensed in 30 gram portions into an aluminum pan and exposed to radiation in the electromagnetic spectrum emitted from a LOCTITE-branded 405 nm CureJet at 100 mW/cm² light intensity for 10 or 30 seconds. Table 3 below captures the data observed.

Sample No. 9 is split into two data points where Sample No. 9a is exposed to radiation in the electromagnetic spectrum for a period of time of 10 seconds and Sample No. 9b is exposed to radiation in the electromagnetic spectrum for a period of time of 30 seconds.

TABLE 3
Sample No.

| 6 | 7 | 8 | 9a | 9b |
|---|---|---|---|---|
| DOC | DOC | DOC | DOC | DOC |
| (mm) | (mm) | (mm) | (mm) | (mm) |
| Max | Max | Max | Max | Max |
| 0 | 24 | 0 | 0 | 24 |

The information captured in Table 3 shows significant depth of cure for Sample Nos. 7 and 9b as compared with the respective controls, Sample Nos. 6, 8 and 9a, with the addition of the fluorescent compound and a 10 second or 30 second exposure to 405 nm radiation at 100 mW/cm² light intensity.

What is claimed is:

1. A photocurable composition comprising:
(a) a (meth)acrylate component;
(b) a (meth)acrylate-functionalized resin component; and
(c) an initiator component comprising a combination of a blue fluorescent compound and a co-initiator, wherein when exposed to a source of radiation at a wavelength of 405 nm at an intensity of 100 mW/cm² for a period of time of at least about 30 seconds, the composition cures to a cured composition exhibiting a depth of cure through a volume of the composition.

2. The composition of claim 1, wherein the blue fluorescent compound should absorb energy below a wavelength of about 400 nm and emit energy above a wavelength of about 400 nm.

3. The composition of claim 1, wherein the blue fluorescent compound should absorb energy at a wavelength of about 180 nm and emit energy at a wavelength of about 600 nm.

4. The composition of claim 1, wherein the blue fluorescent compound comprises 2,5-thiophenediylbis(5-tert-butyl-1,3-benzoxazole).

5. The composition of claim 1, wherein the co-initiator comprises one or more peroxides.

6. The composition of claim 1, wherein the co-initiator comprises benzoyl peroxide.

7. The composition of claim 1, wherein the (meth)acrylate component comprises isobornyl (meth)acrylate and N,N-dimethylacrylamide.

8. The composition of claim 1, wherein the (meth)acrylate component is present in the range of about 25 percent by weight to about 80 percent by weight based on the total weight of the composition.

9. The composition of claim 1, wherein the (meth)acrylate-functionalized resin component comprises one or more of (meth)acrylate-functionalized urethanes, (meth)acrylate-functionalized polyesters, and poly(isobutylene) di(meth)acrylates.

10. The composition of claim 1, wherein the (meth)acrylate-functionalized resin component resin has a number average molecular weight of from about 500 to about 100,000.

11. The composition of claim 1, wherein the (meth)acrylate-functionalized resin component is present in an amount from about 15 to about 50 percent by weight based on the total weight of the composition.

12. The composition of claim 1, wherein the (meth)acrylate-functionalized resin component is present in an amount from about 25 to about 35 percent by weight based on the total weight of the composition.

13. The composition of claim 7, wherein the isobornyl (meth)acrylate of the (meth)acrylate component is present in an amount from about 5 percent by weight to about 50 percent by weight based on the total weight of the composition.

14. The composition of claim 7, wherein the isobornyl (meth)acrylate of the (meth)acrylate component is present in an amount from about 15 to about 40 percent by weight based on the total weight of the composition.

15. The composition of claim 7, wherein the N,N-dimethylacrylamide is present in an amount from about 20 percent by weight to about 30 percent by weight based on the total weight of the composition.

16. The composition of claim 1, wherein the initiator component comprises 2,5-thiophenediylbis(5-tert-butyl-1,3-benzoxazole) as a fluorescent compound, and benzoyl peroxide as a co-initiator.

17. The composition of claim 1, wherein the initiator component is present in an amount from about 0.01 to about 5 percent by weight based on the total weight of the composition.

18. The composition of claim 1, wherein the fluorescent compound of the initiator component is present in an amount from about 0.5 to about 5 percent by weight based on the total weight of the composition.

19. The composition of claim 1, wherein the co-initiator of the initiator component is present in an amount from about 0.01 to about 3 percent by weight based on the total weight of the composition.

20. The composition of claim 1, wherein the fluorescent compound and the co-initiator of the initiator component are present in a by weight ratio of about 1:1 to about 500:1.

21. The composition of claim 1, further comprising a colorant.

22. The composition of claim 1, comprising
(a) isobornyl (meth)acrylate in an amount of about 15 percent by weight to about 40 percent by weight based on the total weight of the composition;
(b) N,N-dimethylacrylamide in an amount of from about 20 percent by weight to about 30 percent by weight based on the total weight of the composition;
(c) (meth)acrylate-functionalized resin in an amount of from about 25 to about 35 percent by weight based on the total weight of the composition; and
(d) as an initiator component, a combination of 2,5-thiophenediylbis(5-tert-butyl-1,3-benzoxazole), and benzoyl peroxide.

23. The composition of claim 1, wherein the (meth)acrylate-functionalized resin component is cyclohexanol, 4,4-(1-methylethylidene)bis-, polymer with 1,3-disocyanatomethylbenzene and tetrahydrofuran, propylene glycol monomer.

24. The composition of claim 1, free of added phosphine oxide photoinitiator.

25. A method of curing a photocurable composition according to claim 1 comprising the steps of:
(a) applying a volume of the composition to at least a first substrate; and
(b) exposing the composition to a source of radiation at a wavelength of 405 nm at an intensity of 100 mW/cm² to cure the composition through a volume of the composition.

26. The method according to claim 25, comprising bonding the first substrate to a second substrate, wherein the first substrate and the second substrate are each parts of medical devices and optionally thereafter sterilizing the bonded assembly created by bonding the first substrate to the second substrate.
